(19) United States
(12) Patent Application Publication
(10) Pub. No.: US 2006/0240753 A1
(43) Pub. Date: Oct. 26, 2006

(54) Abrasive cutting device

(76) Inventor: Carsten Ziegs, Hamburg (DE)

Correspondence Address: KELLY LOWRY & KELLEY, LLP, 6320 CANOGA AVENUE, SUITE 1650, WOODLAND HILLS, CA, 91367, US

(21) Appl. No.: 11/406,876

(22) Filed: Apr. 19, 2006

(30) Foreign Application Priority Data
Apr. 20, 2005 (DE) 202005 006 371.1

(51) Int. Cl. B28D 1/04; B24B 55/02

(52) U.S. Cl. 451/449; 125/13.01

(57) ABSTRACT

In order to provide a power tool, especially a cutting device (10) comprising at least one wet cutting device (11) having a nozzle element (23), wherein the nozzle element (23) is provided for supplying a binding liquid for dust particles formed during the grinding process and can especially be detachably affixed and dismounted from a cutter portion of the cutting device, wherein maintenance is made easier to ensure the function of the wet cutting accessory, it is proposed that the nozzle element (23) can be affixed and dismounted non-positively and/or positively on the cutter portion without tools, for which the nozzle element (23) is affixed to the abrasive cutter portion using a bayonet fixing.

The invention relates to a power tool, especially a cutting device comprising at least one wet cutting device having a nozzle element, wherein the nozzle element is provided for supplying binding liquid for dust particles formed during the grinding process and can especially be detachably affixed and dismounted from a cutter portion of the cutter.

With cutters it is known and usual to wet grinding disks with water so that dust formed during the grinding process is bound and the air pollution is thus kept low.

In this case, a wet cutting accessory is used which can bring water onto the cutting disk by means of nozzles so that dust particles do not pollute the air. The nozzles are affixed to a protective hood, for example, and must be dismounted for maintenance, alteration or repair purposes. A tool must be used both for the first assembly and for said purposes. In practice it has been found that this tool is not available during maintenance or alteration. Therefore maintenance is frequently omitted. The wet cutting accessory then does not work optimally or remains ineffective in the most unfavourable case.

It is the object of the invention to provide a power tool, especially a cutting device where the maintenance is simplified to ensure the function of the wet cutting accessory.

This object is solved by a power tool, especially a cutting device, having the features of claim 1.

In this case, it is provided that the nozzle element can be affixed and dismounted non-positively and/or positively on the cutter portion without tools. Cutter portion is to be understood here as any part of the cutting device on which the nozzle element can be mounted securely and reliably, that is, the protective hood known per se, for example, wherein corresponding receiving openings are constructed.

The invention provides a secure and at the same time simple mounting. The arrangement of the nozzle elements can easily be varied so that different nozzle positions can be implemented.

Since no tool is required for dismantling and assembling the nozzle elements or nozzle fixing elements, it is considerably more likely that maintenance of the wet cutting device will in fact take place. The nozzle elements can easily and conveniently be altered or changed during maintenance.

In addition, as a result of the tool-less assembly according to the invention, no additional fixing means such as screws or the like are used. Thus, a smaller number of parts is required which reduces the manufacturing costs and the assembly costs because fewer parts need to be stored and shorter assembly times are obtained.

According to the invention, the nozzle element can be affixed to the abrasive cutter portion using a bayonet fixing. The bayonet solution has the advantage that by means of a small twist of the nozzle element during assembly a rapid and secure fixing can be achieved without tools. In order to prevent an unintentional loosening of the nozzle element, it is favourable if the bayonet fixing is additionally provided with a locating finger which is embodied so that it acts on the nozzle element or on the abrasive cutter portion to create an anti-rotation element.

In order to allow positioning of a securing ring on the one hand and to create resilient sections on the other hand, it is appropriate if the nozzle element has two concentrically arranged walls wherein the inner wall forms a nozzle channel and the outer wall is constructed as a fixing wall and is spaced from the inner wall. The outer wall is provided with fixing sections whereas the inner portion is constructed as piston- or pin-like to arrange a piston pin ring as a securing element for example.

A good place for fixing the nozzle elements is a protective cover or hood for a cutting disk.

In a further preferred development of the invention, two nozzle elements can be fixed to the protective cover to apply binding liquid to each side of the cutting disk. The action of the wet cutting device is considerably increased by this measure whereby water consumption can be reduced because the side distribution allows more careful metering.

A wet cutting device displays its advantages best in an abrasive cutter which is used for longer cuts and is therefore provided with supporting wheels. The cutting disks are larger than in usual abrasive cutters.

Further advantageous embodiments of the invention are characterised in the dependent claims.

Exemplary embodiments of the invention are explained in detailed with reference to the drawings. Shown purely schematically in the drawings:

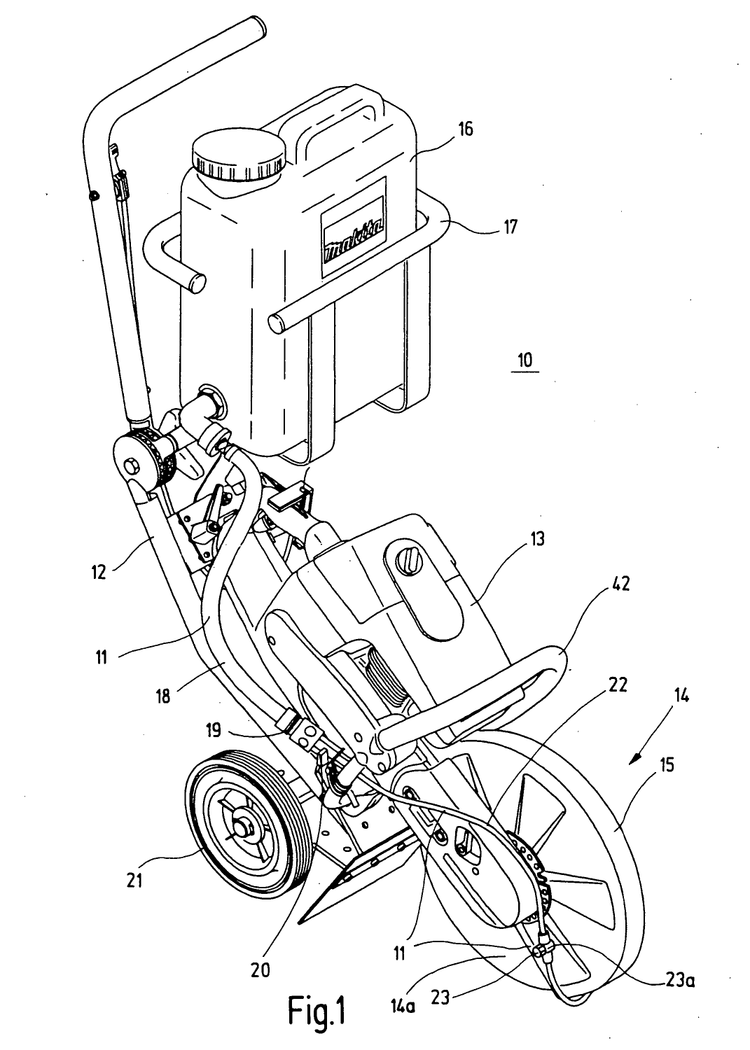

FIG. 1 is a perspective view of an abrasive cutter with a wet cutting accessory according to the invention,

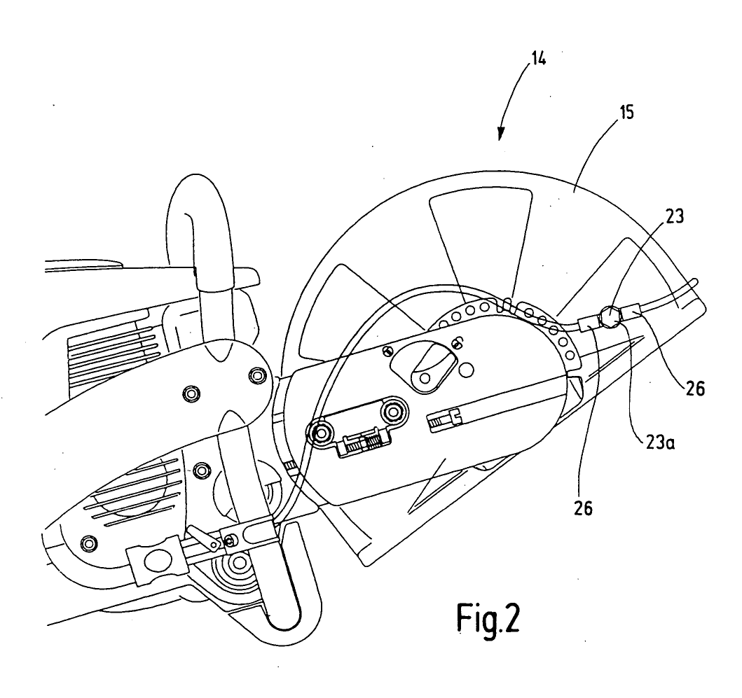

FIG. 2 is a side view of a cutting head of the device shown in FIG. 1,

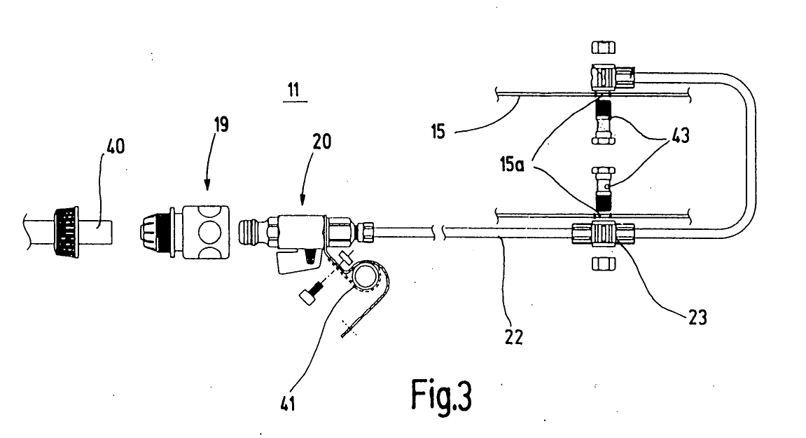

FIG. 3 is a diagram of the wet cutting accessory without the cutter with elements partially dismounted and

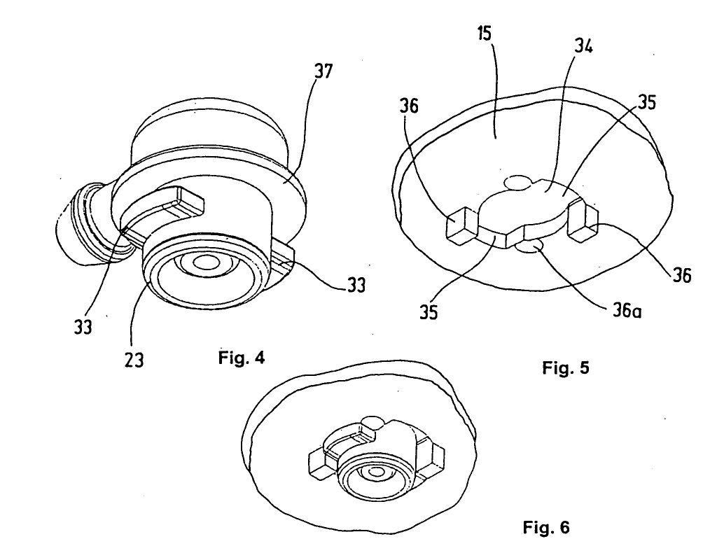

FIGS. 4-6 are perspective views of an embodiment of the nozzle element according to the invention, and

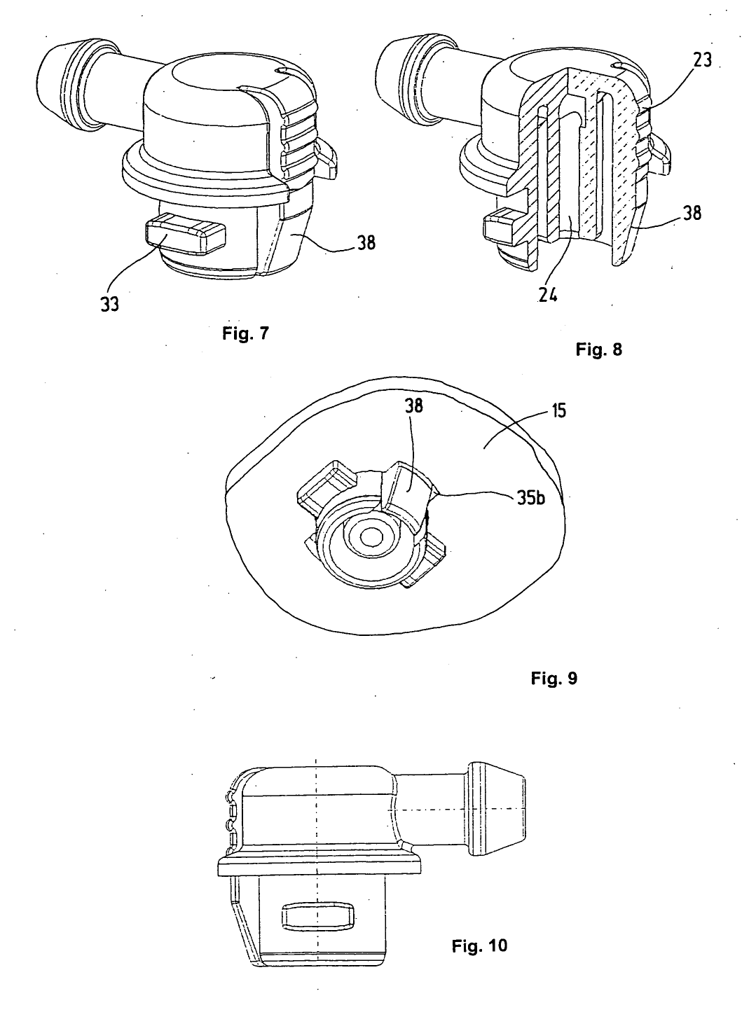

FIGS. 7-10 are perspective and side views of a second embodiment of a nozzle element according to the invention.

FIG. 1 shows a perspective view of an abrasive cutter 10 with a wet cutting accessory 1. The abrasive cutter 10 is mounted on a cart 12 with a motor 13, preferably an internal combustion engine 13. The motor 13 drives a cutting disk 14a disposed on a grinding head 14 which is partly surrounded by a protective hood 15. Located underneath the cart 12 are supporting wheels 21 which carry the device 10.

The wet cutting accessory 11 comprises a water tank 16 which is held by a holder 17 on the cart 12. A hose 18 comes out from the water tank 16 and passes via a coupling portion 19 and a valve 20 as well as a hose 22. Located on the hose 22 are two nozzle elements 23 which are affixed to the protective hood 15.

The nozzle elements 23 are provided for supplying binding liquid (water) for dust particles produced during the grinding process or cutting process and can be detachably affixed and dismounted on the protective hood 16 (abrasive cutter portion) by means of a tool, for maintenance purposes for example. FIG. 2 shows an enlarged view of the protective hood 15 or the grinding head 14.

FIG. 3 shows the wet cutting accessory 11 without the cutter 10. This consists of a hose 40, the coupling portion 19, the valve 20, a fixing means 41, the hose 22, the nozzle elements 23 and the protective hood 15 with the receiving openings 15a. As shown in FIG. 3, the nozzle elements 23 (nozzle fixing elements) can be provided with removable nozzles 43.

FIGS. 4-6 show a first embodiment of the nozzle element 23 according to the invention. According to the invention, the nozzle elements 23 can be detachable affixed and dismounted positively and non-positively on the protective hood without tools. In this solution the nozzle element is affixed to the protective hood 15 using a bayonet fixing. The nozzle element 23 has two opposing pins 33, as shown in FIG. 10. These are inserted through the opening 34 in the protective hood 15. For this purpose the opening 34 is provided with two bayonet indentations 35. Two stops 36 delimit a rotary movement of the nozzle element through 90° as shown in FIG. 12. The two “protuberances” 36a shown in FIG. 11 must be overcome during the rotary movement. These prevent the nozzle elements 23 from unintentionally being pressed out or falling out.

FIGS. 7-10 show a second embodiment of a nozzle element 23 according to the invention. In this case, the bayonet fixing is additionally provided with a securing finger 38 which is embodied so that it acts on the opening 34 to provide an anti-rotation element. The opening 34 has an additional locking indentation 35b for the securing finger 38. In the closed position (FIG. 9) the finger engages in the locking indentation 35b and prevents any twisting before this is pressed inwards again.

All the fingers 27, 38 can have a structured surface to facilitate gripping.

### REFERENCE LIST

10 Abrasive cutter
11 Wet cutting accessory
12 Cart
13 Motor
14 Grinding head
14a Cutting disk
15 Protective hood
15a Opening
16 Water tank
17 Holder
18 Hose
19 Coupling portion
20 Valve
21 Supporting wheels
22 Hose
23 Nozzle elements
23a Interposed nozzle element
33 Pin
34 Opening
35 Bayonet indentations
35b Locking indentation
36 Stops
36a Protuberances
37 Mounting surface
38 Securing finger
40 Hose
41 Fixing means
42 Front handle
43 Nozzle which can be removed using tool (prior art)

1. A power tool, especially a cutting device (10) comprising at least one wet cutting device (11) having a nozzle element (23), wherein the nozzle element (23) is provided for supplying binding liquid for dust particles formed during the grinding process and can especially be detachably affixed and dismounted from a cutter portion of the cutting device (10), characterised in that the nozzle element (23) can be affixed and dismounted non-positively and/or positively on the cutter portion without tools, for which the nozzle element (23) is affixed to the cutter portion using a bayonet fixing.

2. The power tool, especially cutting device according to claim 1, characterised in that the bayonet fixing is additionally provided with a locating finger (38) which is embodied so that it acts on the nozzle element (23) or on the abrasive cutter portion to create an anti-rotation element.

3. The power tool, especially cutting device according to claim 1, characterised in that the cutter portion comprises a protective cover (15) for a cutting disk (14a).

4. The power tool, especially cutting device according to claim 3, characterised in that two nozzle elements (23) can be fixed to the protective cover (15) to apply binding liquid to each side of the cutting disk (14a).
